(19) United States
(12) Patent Application Publication
(10) Pub. No.: US 2006/0267499 A1
(43) Pub. Date: Nov. 30, 2006

(54) Plasma display panel (PDP)

(76) Inventors: Sung-Hune Yoo, Chunan (KR); Hyuk-Kwan Kwon, Yongin (KR)

Correspondence Address: Robert E. Bushnell, Suite 300, 1522 K Street, N.W., Washington, DC, 20005, US

(21) Appl. No.: 11/430,248

(22) Filed: May 9, 2006

(30) Foreign Application Priority Data
May 30, 2005 (KR) 10-2005-0045470

(51) Int. Cl. H01J 17/49

(52) U.S. Cl. 313/582

(57) ABSTRACT

A Plasma Display Panel (PDP) includes a front substrate having at least a portion colored; a rear substrate arranged to face the front substrate and spaced apart from the front substrate by a gap that is divided into a plurality of discharge spaces; a phosphor layer arranged inside the discharge space; a plurality of transparent electrodes arranged on the front substrate at locations respectively corresponding to the plurality of discharge spaces; bus electrodes connected to the transparent electrodes; and a dielectric layer covering the transparent electrodes and the bus electrodes. The front substrate is colored with a color which is complementary, based on subtractive mixing, to a color of the dielectric layer when it is discolored.

### CLAIM OF PRIORITY

This application makes reference to, incorporates the same herein, and claims all benefits accruing under 35 U.S.C. §119 from an application for PLASMA DISPLAY PANEL earlier filed in the Korean Intellectual Property Office on the 30^{th} of May 2005 and there duly assigned Serial No. 10-2005-0045470.

### BACKGROUND OF THE INVENTION

1. Field of the Invention

The present invention relates to a Plasma Display Panel (PDP) and, in particular, to a PDP that enhances a bright room contrast ratio and can be manufactured in a simplified process while reducing its failure rate.

2. Description of the Related Art

Plasma Display Panels (PDPs) are classified as Direct Current (DC) PDPs, Alternating Current (AC) PDPs, and hybrid PDPs with respect to the kind of driving voltage supplied to a discharge cell. Also, PDPs are classified into face discharge PDPs and surface discharge PDPs with respect to their discharge structure.

Since direct movement of charges between the corresponding electrodes severely damages the electrodes in DC PDPs, AC surface discharge PDPs have been widely used recently.

Such PDPs have excellent characteristics including high picture quality, slim thickness, light weight, and wide viewing angle. Also, due to their simple manufacturing processes compared to other flat displays and easy enlargement in screen size, these PDPs have received much attention as thin display devices for the next era.

However, these PDPs have a shortcoming of a relatively low contrast ratio. Depending on the electrode material, a dielectric substance surrounding the electrode can react with the electrode so that the dielectric substance becomes discolored.

### SUMMARY OF THE INVENTION

Therefore, the present invention provides a Plasma Display Panel (PDP) with an improved contrast ratio, specifically an improved bright room contrast ratio, with the deterioration in quality due to the discolored dielectric layer being suppressed, and with their overall manufacturing process being simplified.

A Plasma Display Panel (PDP) according to an embodiment of the present invention includes: a front substrate having at least a colored portion; a rear substrate arranged to face the front substrate and spaced apart from the front substrate by a gap divided into a plurality of discharge spaces; a phosphor layer arranged inside the plurality of discharge spaces; a plurality of transparent electrodes arranged on the front substrate at locations respectively corresponding to the plurality of discharge spaces; bus electrodes connected to the plurality of transparent electrodes; and a dielectric layer covering the plurality of transparent electrodes and the bus electrodes, wherein the colored portion of the front substrate is a color which is complementary, based on subtractive mixing, with a color of the dielectric layer upon it being discolored.

Each of the plurality of transparent electrodes preferably includes a first transparent electrode and a second transparent electrode, both formed in each discharge space and facing each other, and the bus electrode preferably includes a first bus electrode connected to the first transparent electrodes and a second bus electrode, arranged parallel to the first bus electrode, and connected to the second transparent electrodes.

The PDP preferably further includes address electrodes, arranged on the rear substrate, and extending in a direction crossing the first and second bus electrodes.

Barrier ribs are preferably arranged between the front substrate and the rear substrate to define a plurality of discharge spaces.

The bus electrodes preferably include a material containing silver.

The front substrate is preferably a transparent substrate having a color that is complementary, based on subtractive mixing, with a color of the dielectric layer upon it being discolored.

The resultant color from the color of the front substrate and the color of the discolored dielectric layer is preferably one of gray or black through subtractive mixing.

The front substrate is preferably a violet-toned color. The colored front substrate preferably further includes a filtering film attached thereto, the filtering film having a color that is complementary, based on subtractive mixing, with a color of the dielectric layer upon it being discolored. The filtering film is preferably colored only in a region corresponding to the bus electrodes of the front substrate. The filtering film is preferably attached only in a region corresponding to the bus electrodes of the front substrate.

A Plasma Display Panel (PDP) according to another embodiment of the present invention includes: a front substrate having at least a colored portion; a rear substrate arranged facing the front substrate and spaced apart from the front substrate by a gap divided into a plurality of discharge spaces; a phosphor layer arranged inside the plurality of discharge spaces; a plurality of transparent electrodes arranged on the front substrate at locations respectively corresponding to the plurality of discharge spaces; bus electrodes connected to the plurality of transparent electrodes; a dielectric layer covering the plurality of transparent electrodes and the bus electrodes; and a filtering film attached to an outer surface of the front substrate, wherein the color of the filtering film is complementary, based on subtractive mixing, with a color of the dielectric layer upon it being discolored.

Each of the plurality of transparent electrodes preferably includes a first transparent electrode and a second transparent electrode, both arranged in each discharge space and facing each other, and each bus electrode includes a first bus electrode connected to the first transparent electrodes, and a second bus electrode, arranged parallel to the first bus electrode, and connected to the second transparent electrodes.

Address electrodes are preferably arranged on the rear substrate, extending in a direction crossing the first and second bus electrodes.

Barrier ribs are preferably arranged between the front substrate and the rear substrate to define a plurality of discharge spaces.

The bus electrodes preferably include a material containing silver.

The filtering film is preferably colored only in a region corresponding to the bus electrodes of the front substrate. The filtering film is preferably attached only in a region corresponding to the bus electrodes of the front substrate. The filtering film is preferably a violet-toned color. The resultant color from the color of the filtering film and the color of the discolored dielectric layer is preferably one of gray or black through subtractive mixing.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a partial perspective view of a disassembled PDP according to a first embodiment of the present invention.

FIG. 2 is a partial cross-sectional view of the assembled PDP taken along a line II-II of FIG. 1.

FIG. 3 is a partial schematic plan view of the arrangement of electrodes of the PDP of FIG. 1.

FIG. 4 is a partial cross-sectional view of an assembled PDP according to a second embodiment of the present invention.

FIG. 5 is a partial schematic plan view of the arrangement of electrodes of the PDP of FIG. 4.

### DETAILED DESCRIPTION OF THE INVENTION

Hereinafter, a detailed description of a Plasma Display Panel (PDP) according to the embodiments of the present invention follows with reference to the accompanying drawings. The drawings schematically show a three-electrode surface discharge AC PDP. However, these embodiments have been merely chosen to exemplify the present invention, and the present invention is not limited to these embodiments.

Throughout the specification, the same reference numerals are designated for the same or similar components. The first embodiment is explained, and for subsequent embodiments, an explanation is only provided for components that are different from the first embodiment. In order to clarify the explanation of the present invention, information that is irrelevant has been omitted.

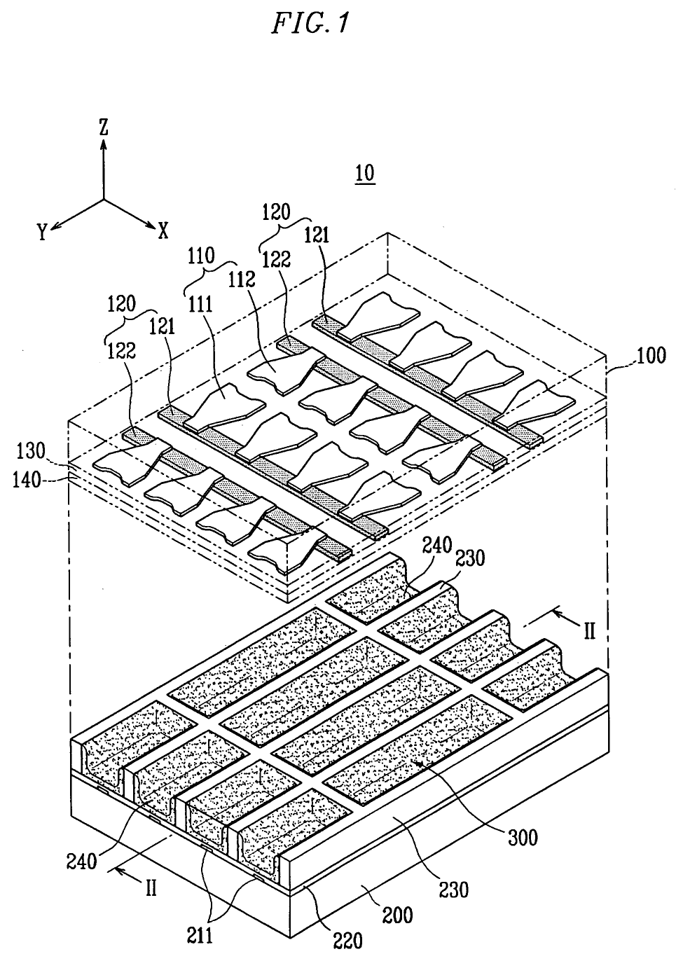

As shown in FIG. 1, a Plasma Display Panel (PDP) 10 according to a first embodiment of the present invention includes a front substrate 100 that has at least a portion colored with a predetermined color; a rear substrate 200 facing the front substrate 100 and spaced apart from the front substrate 100 by a gap that is divided into a plurality of independent discharge spaces 300; barrier ribs 230 formed between the front substrate 100 and the rear substrate 200 so as to define the plurality of independent discharge spaces 300; a phosphor layer 240 formed inside the discharge spaces 300; a plurality of transparent electrodes 110 formed on the front substrate 100 at locations corresponding respectively to the plurality of discharge spaces 300; bus electrodes 120 in direct contact with the transparent electrodes 110 for supplying electrical driving signals to the transparent electrodes 110; a dielectric layer 130 covering the transparent electrodes 110 and the bus electrodes 120; and a protective layer 140 covering the dielectric layer 130.

Each transparent electrode 110 includes a first transparent electrode 111 and a second transparent electrode 112, both formed in each discharge space 300 and facing each other, and each bus electrode 120 includes a first bus electrode 121 connected to the first transparent electrodes 111 and a second bus electrode 122 connected to the second transparent electrodes 112 and placed parallel to the first bus electrode 121. The rear substrate 200 of the PDP 10 can have address electrodes 211 formed thereon and extending in a direction crossing the first and second bus electrodes 121 and 122. The address electrodes 211 can be covered with a dielectric layer 220. Also, the PDP 10 includes a discharge gas (not shown in the drawings) filling the discharge spaces 300.

Both the front and rear substrates 100 and 200 are made of an insulating material such as glass. The front substrate 100 is a transparent substrate of which at least a portion is colored with a predetermined color. At least a portion of the front substrate 100 has a color that is in a complementary color relationship based on subtractive mixing with the color that the dielectric layer 130 changes to, which will be described later.

In a first embodiment of the present invention, the front substrate 100 itself has a predetermined color. That is, the front substrate 100 itself is colored in the forming process of the transparent front substrate made of an insulating material such as glass.

The barrier ribs 230 can be formed on the rear substrate 200 or on the front substrate 100. Alternatively, the barrier ribs 230 can be formed on both substrates 100 and 200 separately or integrally. In the present embodiment, the barrier ribs 230 are formed on the rear substrate 200 to define the plurality of discharge space 300 independently. Also, the barrier ribs 230 can form the discharge spaces 300 with various shapes such as a circular pipe, an elliptical pipe, or a polygonal pipe shape. The first embodiment of the present invention exemplarily shows the discharge space 300 in a shape of a rectangular pipe. In other words, the barrier ribs 230 can be formed in various patterns and by various methods as long as a plurality of the discharge spaces 300 can be obtained.

Each discharge space 300 is coated with a phosphor layer 240 that absorbs vacuum ultraviolet rays and emits visible light rays, and is filled with a discharge gas (for example, a gas mixture of neon, xenon, etc.) that generates vacuum ultraviolet rays by a plasma discharge.

The phosphor layer 240 can be formed on the inner sidewalls of the barrier ribs 230 which form the discharge spaces 300, and on either or both of the front and rear substrates 100 and 200 which form the discharge space 300. When the phosphor layer 240 is formed on the rear substrate 200, the phosphor layer 240 is made of reflective phosphors that absorb vacuum ultraviolet rays inside the discharge space 300 and reflect visible light rays towards the front substrate 100. On the contrary, when the phosphor layer 240 is formed on the front substrate 100, the phosphor layer 240 is made of transmitting phosphors that absorb vacuum ultraviolet rays inside the discharge space 300 and transmit visible light rays. In other words, the phosphor layer 240 can be formed in various arrangements in accordance with the electrode structure and discharging method used in the PDP 10. In the first embodiment of the present invention, the phosphor layer 240 is formed on the barrier ribs 230 and on the rear substrate 200, and this is advantageous for improving transmittance of visible light rays.

In the present embodiment, the PDP 10 generates plasma discharge inside the discharge spaces 300 by means of a three-electrode structure including the first transparent electrode 111, the second transparent electrode 112, and the address electrode 211. The first and second bus electrodes 121 and 122 play the same role as that of the first and second transparent electrodes 111 and 112. The first and second transparent electrodes 111 and 112 are formed facing each other with a gap therebetween on the front substrate 100, and the address electrode 211 is formed on the rear substrate 200.

However, the electrode structure in the present invention is not limited to the aforementioned embodiments and can have various forms, including a two-electrode structure, for example. In addition, the first and second transparent electrodes 111 and 112 can vary in shape according to the shape of the discharge space 300 and for optimization of discharge efficiency.

An address discharge occurs by supplying an address voltage between the address electrode 211 where address pulses are imposed and the second transparent electrode 112 that serves as a scan electrode where scan pulses are imposed. A sustain discharge occurs between the first transparent electrode 111 and the second transparent electrode 112, both serving as sustain electrodes.

The first and second transparent electrodes 111 and 112 can be made of Indium Tin Oxide (ITO), a transparent and electrically conductive material. However, ITO first and second transparent electrodes 111 and 112 have a low electrical conductance due to their relatively high electrical resistance. Therefore, the first bus electrode 121 and the second bus electrode 122 are respectively connected to the first and second transparent electrodes 111 and 112 that are formed in each discharge space, and serve to convey electrical driving signals to the first and second transparent electrodes 111 and 112. The first and second bus electrodes 121 and 122 and the address electrode 211 are formed of a material with a high electrical conductivity, such as aluminum, copper, and silver. In the first embodiment of the present invention, the first and second bus electrodes 121 and 122 are made of a material containing silver (Ag). In order to minimize the blocking of outgoing visible light rays by the first and second bus electrodes 121 and 122, the first and second bus electrodes 121 and 122 are respectively connected to the first and second transparent electrodes 111 and 112 at each outer edge of the first and second transparent electrodes 111 and 112.

The dielectric layers 130 and 220 are formed to prevent an electrical current from flowing directly between the electrodes, such as the first and second transparent electrodes 111 and 112, the first and second bus electrodes 121 and 122, and the address electrode 211 during the discharge period. Also, the dielectric layers 130 and 220 serve to form and accumulate wall charges as well as to avoid damage to the electrodes by blocking ions (positive charges) or electrons from colliding directly with the electrodes. A a transparent dielectric material is used for the dielectric layer 130 (hereinafter referred to as the transparent dielectric layer) covering the first and second transparent electrodes 111 and 112 and the first and second bus electrodes 121 and 122. In order to reflect most of the visible light rays emitted from the phosphor layer toward the front substrate 100, a white dielectric material is used for the dielectric layer 220 (hereinafter referred to as the reflective dielectric layer) covering the address electrodes 211.

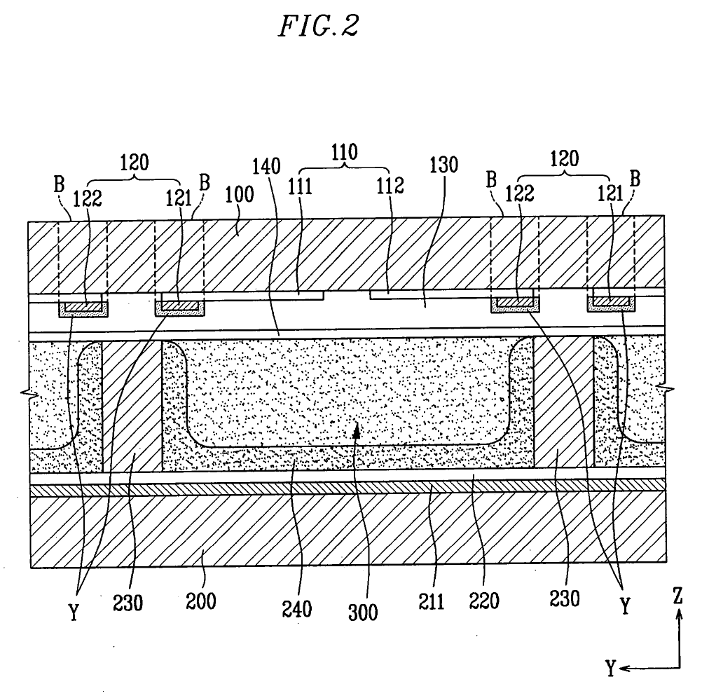

As shown in FIG. 2, when the first and second bus electrodes 121 and 122 are made of a material containing silver (Ag), the transparent dielectric layer 130 becomes yellow in the region (Y) near the first and second bus electrodes 121 and 122 due to the silver component of the first and second bus electrodes 121 and 122.

On the other hand, the front substrate 100 is colored with a color that is complementary, based on subtractive mixing, to the color that the transparent dielectric layer 130 changes to by its reaction with the component of the first and second bus electrodes 121 and 122. In the present invention, since the yellow appears in partial regions (Y) of the transparent dielectric layer 130 adjacent to the first and second bus electrodes 121 and 122, a portion at least of the front substrate 100 including the region corresponding to the first and second bus electrodes 121 and 122 is colored violet, which is the complementary color to yellow, based on subtractive mixing.

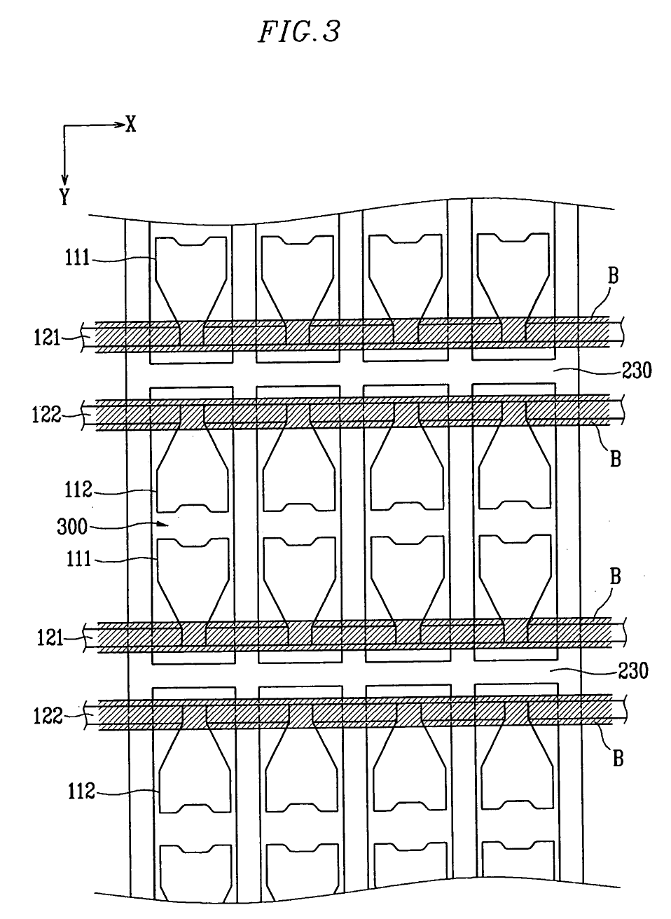

Therefore, as illustrated in FIG. 3, the front substrate 100 seen from the front appears dark black in the overlapped region (B) (hereinafter referred to as the black region) between the violet-colored region of the front substrate 100 and the yellow region of the transparent dielectric layer 130. The black region (B) demarcates different colors emitted from discharge spaces 300 and can improve a contrast ratio of the PDP, specifically a bright room contrast ratio, by reducing outside light reflection.

Furthermore, the front substrate 100 colored with the complementary color, based on subtractive mixing, can suppress deterioration in appearance quality of the PDP due to the yellowing of the transparent dielectric layer 130.

Generally, the first and second bus electrodes 121 and 122 containing silver appear white in color, so the bright room contrast ratio is not good due to the increase in outside light reflection. Another solution to tackle this problem is to form the first and second bus electrodes 121 and 122 to be double-layered with a black metallic layer adjacent to the side of the front substrate 100, and a white metallic layer containing silver. However, such double-layered first and second bus electrodes 121 and 122 increase the electrical resistance thereof to cause the consumption of reactive power. Also, the double layered structure requires a complicated manufacturing process. By contrast, the present invention does not have such shortcomings.

On the other hand, the discoloration of the transparent dielectric layer 130 is not limited to yellow and can show various colors, depending on the component contained in the first and second bus electrodes 121 and 122 or surrounding conditions. Therefore, the color that the front substrate 100 is colored with is not limited to violet. The front substrate 100 can be colored with any color that is complementary to the color that the transparent dielectric layer 130 changes to.

The protective layer 140 protects the transparent dielectric layer 130 that is exposed to the plasma discharge generated inside the discharge space 300. Also, the protective layer 140 should have a high secondary electron-emission coefficient and high transmittance for visible light rays. Therefore, the protective layer 140 is made of a magnesium oxide (MgO) material that transmits visible light rays. The protective layer 140 serves to protect the weak dielectric layer and to reduce the firing voltage by emitting many secondary electrons during the discharging period. A detailed explanation is given hereinafter of an exemplary discharging process in the PDP according to the embodiment of the present invention.

Firstly, the discharge space 300 to be turned on is selected when the address pulse and the scan pulse are respectively supplied to the address electrode 211 and the second transparent electrode 112 from an external power source, so that a predetermined address voltage is supplied between the address electrode 211 and the second transparent electrode 112. Wall charges are accumulated on the second transparent electrode 112 of the selected discharge space 300. This period is called the addressing discharge period. Thus, in order to address one discharge space 300, the address electrode 211 and the second bus electrode 122 connected to the second transparent electrode 112 serving as the scan electrode should extend respectively in mutually crossing directions.

Secondly, when a positive voltage is supplied to the first transparent electrode 111, and a voltage relatively lower than the positive voltage is supplied to the second transparent electrode 112, the wall charges move by the difference in voltages supplied between the first and second transparent electrodes 111 and 112. A discharge is caused by the moving wall charges colliding with the atoms of the discharge gas filling the discharge space 300, and as a result, a plasma is generated. The discharge starts in the regions close to both the first and second transparent electrodes 111 and 112, that is, in the transparent dielectric layer 130 or the protective layer 140, forming a relatively strong electric field. As time passes, while keeping the large difference in voltage between the first and second transparent electrodes 111 and 112, the aforementioned electric field formed in the transparent dielectric layer 130 or the protective layer 140 becomes stronger and causes the discharge to spread into the entire discharge space 300. As a result, vacuum ultraviolet rays generated by the plasma discharge collide with the phosphor layer 240 to produce visible light rays of a predetermined color.

After forming such a discharge, the difference in voltage between the first and second transparent electrodes 111 and 112 decreases. Then, the discharge no longer occurs, and the space charges and the wall charges are formed in the discharge space 300. The polarity of the voltage between the first and second transparent electrodes 111 and 112 is then reversed, and the discharge starts again with the help of the wall charges. By repeating such a process, the discharge is stably generated. In the discharge space 300 selected by the address discharge, the first transparent electrodes 111 serving as sustain electrodes and the second transparent electrodes 112 serving as scan electrodes produce the sustain discharge by the sustain pulses alternately supplied to the first and second transparent electrodes 111 and 112. That produces an image on the PDP. This period is called the sustain discharge period.

In the present invention, the discharge is not limited to the embodiment described in detail hereinabove, and many variations of the discharge fall within the scope of the present invention.

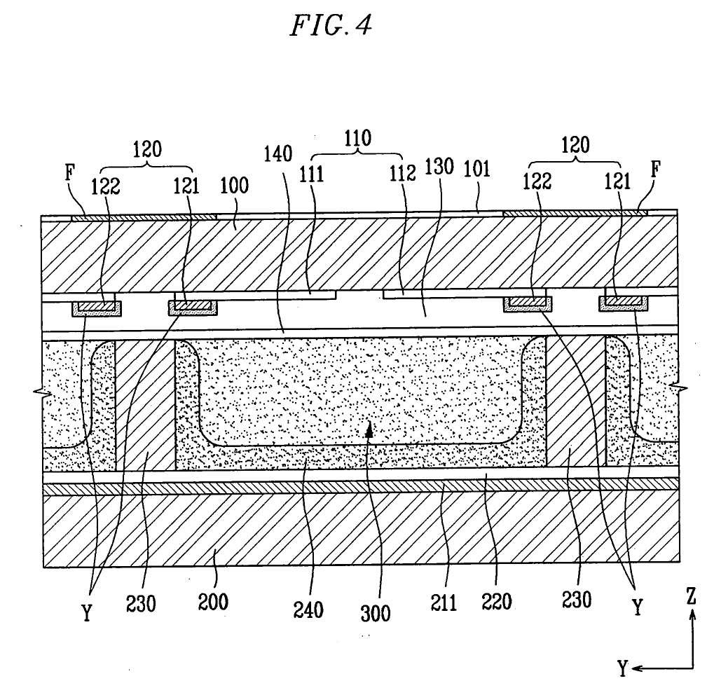

A PDP according to a second embodiment of the present invention is described below with reference to FIG. 4.

As shown in FIG. 4, the PDP 10 includes a filtering film 101 attached to the outer surface of the front substrate 100 and having a complementary color, based on subtractive mixing, to the color that the transparent dielectric layer 130 changes to. That is, at least a part of the front substrate 100 is colored by attaching the filtering film 101 to the transparent substrate, the filtering film 101 having the complementary color, based on subtractive mixing, to the color that appears in the transparent dielectric layer 130 by the reaction between the transparent dielectric layer 130 and silver contained in the first and second bus electrodes 121 and 122.

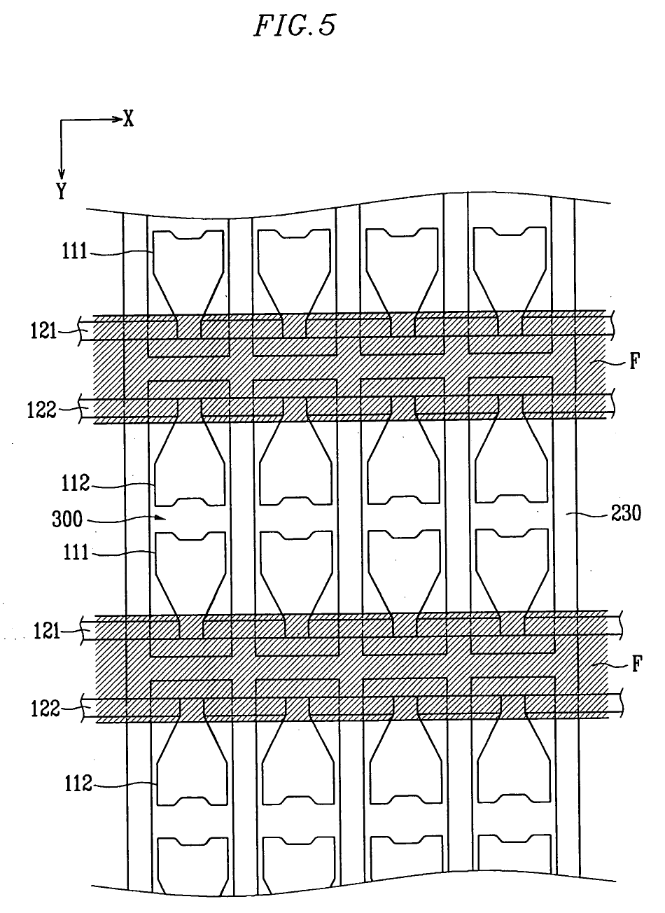

As illustrated in FIG. 5, the filtering film 101 is attached to the entire outer surface of the front substrate 100 and has the color only in colored regions (F) that correspond to the first and second bus electrodes 121 and 122. However, the present invention is not limited to this example, and the filtering film 101 can be attached to only the colored regions (F) including the discolored regions (Y) of the transparent dielectric layer 130.

A dark blackish color appears in the overlapped area of the colored region (F) where the filtering film is attached to the discolored region of the transparent dielectric layer 130. Accordingly, as in the previous embodiment, this dark region demarcates different colors emitted from discharge spaces 300 and can improve the contrast ratio of the PDP, specifically the bright room contrast ratio, by reducing outside light reflection. In addition, the deterioration in appearance quality of the PDP by yellowing of the transparent dielectric layer 130 can be suppressed. In terms of fidelity of the color emitted from the discharge space 300, a filtering film having the color only in the colored regions (F) is preferable to a filtering film having the color in the entire film area. This is because the color of the filtering film covering the non-discolored region can change the original color emitted by the discharge space 300.

Although embodiments of the present invention have been described in detail hereinabove, it should be clearly understood that many variations and/or modifications of the basic inventive concepts herein taught will still fall within the spirit and scope of the present invention, as defined in the appended claims.

The PDP according to the present invention uses a transparent front substrate that is colored with a predetermined color or a transparent front substrate having a filtering film attached thereto that is colored with a predetermined color so that different colors emitted from discharge spaces 300 are effectively demarcated, and so that a contrast ratio of the PDP, specifically a bright room contrast ratio, is improved by reducing outside light reflection.

Also, the deterioration in quality of the PDP due to the discolored dielectric layer is suppressed, and the overall manufacturing process can be simplified.

What is claimed is:

1. A Plasma Display Panel (PDP), comprising:
a front substrate having at least a colored portion;
a rear substrate arranged to face the front substrate and spaced apart from the front substrate by a gap divided into a plurality of discharge spaces;
a phosphor layer arranged inside the plurality of discharge spaces;
a plurality of transparent electrodes arranged on the front substrate at locations respectively corresponding to the plurality of discharge spaces;
bus electrodes connected to the plurality of transparent electrodes; and
a dielectric layer covering the plurality of transparent electrodes and the bus electrodes, wherein the colored portion of the front substrate is a color which is complementary, based on subtractive mixing, with a color of the dielectric layer upon it being discolored.

2. The PDP of claim 1, wherein each of the plurality of transparent electrodes includes a first transparent electrode and a second transparent electrode, both formed in each discharge space and facing each other, and wherein the bus electrode includes a first bus electrode connected to the first transparent electrodes and a second bus electrode, arranged parallel to the first bus electrode, and connected to the second transparent electrodes.

3. The PDP of claim 2, further comprising address electrodes, arranged on the rear substrate, and extending in a direction crossing the first and second bus electrodes.

4. The PDP of claim 1, wherein barrier ribs are arranged between the front substrate and the rear substrate to define a plurality of discharge spaces.

5. The PDP of claim 1, wherein the bus electrodes comprise a material containing silver.

6. The PDP of claim 1, wherein the front substrate is a transparent substrate having a color that is complementary, based on subtractive mixing, with a color of the dielectric layer upon it being discolored.

7. The PDP of claim 6, wherein the resultant color from the color of the front substrate and the color of the discolored dielectric layer is one of gray or black through subtractive mixing.

8. The PDP of claim 1, wherein the front substrate is a violet-toned color.

9. The PDP of claim 1, wherein the colored front substrate further comprises a filtering film attached thereto, the filtering film having a color that is complementary, based on subtractive mixing, with a color of the dielectric layer upon it being discolored.

10. The PDP of claim 9, wherein the filtering film is colored only in a region corresponding to the bus electrodes of the front substrate.

11. The PDP of claim 9, wherein the filtering film is attached only in a region corresponding to the bus electrodes of the front substrate.

12. A Plasma Display Panel (PDP), comprising:
a front substrate having at least a colored portion;
a rear substrate arranged facing the front substrate and spaced apart from the front substrate by a gap divided into a plurality of discharge spaces;
a phosphor layer arranged inside the plurality of discharge spaces;
a plurality of transparent electrodes arranged on the front substrate at locations respectively corresponding to the plurality of discharge spaces;
bus electrodes connected to the plurality of transparent electrodes;
a dielectric layer covering the plurality of transparent electrodes and the bus electrodes; and
a filtering film attached to an outer surface of the front substrate, wherein the color of the filtering film is complementary, based on subtractive mixing, with a color of the dielectric layer upon it being discolored.

13. The PDP of claim 12, wherein each of the plurality of transparent electrodes includes a first transparent electrode and a second transparent electrode, both arranged in each discharge space and facing each other, and wherein each bus electrode includes a first bus electrode connected to the first transparent electrodes, and a second bus electrode, arranged parallel to the first bus electrode, and connected to the second transparent electrodes.

14. The PDP of claim 13, wherein address electrodes are arranged on the rear substrate, extending in a direction crossing the first and second bus electrodes.

15. The PDP of claim 12, wherein barrier ribs are arranged between the front substrate and the rear substrate to define a plurality of discharge spaces.

16. The PDP of claim 12, wherein the bus electrodes comprise a material containing silver.

17. The PDP of claim 12, wherein the filtering film is colored only in a region corresponding to the bus electrodes of the front substrate.

18. The PDP of claim 12, wherein the filtering film is attached only in a region corresponding to the bus electrodes of the front substrate.

19. The PDP of claim 12, wherein the filtering film is a violet-toned color.

20. The PDP of claim 12, wherein the resultant color from the color of the filtering film and the color of the discolored dielectric layer is one of gray or black through subtractive mixing.
